(19) United States
(12) Patent Application Publication
(10) Pub. No.: US 2024/0298621 A1
(43) Pub. Date: Sep. 12, 2024

(54) GRIP ATTACHMENT FOR A RAIL ROD AND REEL ASSEMBLY

(71) Applicant: Clifford LAU, Irvine, CA (US)

(72) Inventor: Clifford LAU, Irvine, CA (US)

(21) Appl. No.: 18/181,500

(22) Filed: Mar. 9, 2023

(51) Int. Cl. A01K 87/08

(52) U.S. Cl. CPC A01K 87/08

(57) ABSTRACT

A grip attachment for a rail rod and reel assembly is disclosed. The grip attachment includes a grip handle and an attachment plate. The grip attachment assists a user of a rail rod and reel to reel in large fish. The grip attachment can additionally include a removable plate and a tensioning element.

### FIELD OF THE DISCLOSURE

This relates generally to a grip attachment, and more particularly to a grip attachment for a rail rod and reel assembly.

### BACKGROUND OF THE DISCLOSURE

Large fish caught on a fishing rod require a lot of force to reel in. The user typically leverages the fishing rod against the rail of a fishing boat like a seesaw to increase control over the rod and reel assembly while reeling in the fish.

### BRIEF SUMMARY OF THE DISCLOSURE

Aspects of the present disclosure relate to a grip attachment for a rail rod and reel assembly. In some embodiments, the grip attachment includes an attachment plate and a grip handle. The attachment plate may include a plurality of bolt holes with a first dimension (e.g., a first diameter) and a first pitch. The grip handle may protrude from a first surface of the attachment plate on a first side of the attachment plate opposite from a reel crank. The grip handle may be configured to be held by the non-reeling hand of a user operating the rail rod and reel assembly to provide additional control while reeling in fish.

In some embodiments, the grip attachment includes a removable mounting plate. The removable mounting plate may be received by the attachment plate at a second surface opposite from the first surface, from which the grip handle protrudes. The removable mounting plate may include a plurality of bolt holes with a second dimension (e.g., second diameter) smaller than the first dimension (e.g., first diameter) and/or a second pitch different than the first pitch. The bolt holes on the removable mounting plate may at least partially overlap the bolt holes on the attachment plate to enable insertion of mounting screws (or the like) through bolt holes of the removable mounting plate and the attachment plate.

In some embodiments, the grip attachment includes a tensioning element. The tensioning element protrudes from the first surface of the attachment plate on a second side of the attachment plate, opposite from the first side of the attachment plate where the grip attachment is located. The tensioning element may include a spring and/or a screw (or the like). The tensioning element may provide stability to the grip attachment.

The full descriptions of these embodiments are provided in the Drawings and the Detailed Description, and it is understood that this Summary does not limit the scope of the disclosure in any way.

### BRIEF DESCRIPTION OF THE DRAWINGS

FIGS. 1A-1B illustrate different views of an example embodiment of a grip attachment for a rail rod and reel assembly.

FIG. 2 is an illustration of the grip attachment mounted to the rail rod and reel assembly.

### DETAILED DESCRIPTION OF THE DISCLOSURE

In the following description of embodiments, reference is made to the accompanying drawings which form a part hereof, and in which it is shown by way of illustration specific embodiments that can be practiced. It is to be understood that other embodiments can be used, and structural changes can be made without departing from the scope of the disclosed embodiments.

Aspects of the present disclosure relate to a grip attachment for a rail rod and reel assembly. In some embodiments, the grip attachment includes an attachment plate and a grip handle. The attachment plate may include a plurality of bolt holes with a first dimension (e.g., a first diameter) and a first pitch. The grip handle may protrude from a first surface of the attachment plate on a first side of the attachment plate opposite from a reel crank. The grip handle may be configured to be held by the non-reeling hand of a user operating the rail rod and reel assembly to provide additional control while reeling in fish.

In some embodiments, the grip attachment includes a removable mounting plate. The removable mounting plate may be received by the attachment plate at a second surface opposite from the first surface, from which the grip handle protrudes. The removable mounting plate may include a plurality of bolt holes with a second dimension (e.g., second diameter) smaller than the first dimension (e.g., first diameter) and/or a second pitch different than the first pitch. The bolt holes on the removable mounting plate may at least partially overlap the bolt holes on the attachment plate to enable insertion of mounting screws (or the like) through bolt holes of the removable mounting plate and the attachment plate.

In some embodiments, the grip attachment includes a tensioning element. The tensioning element protrudes from the first surface of the attachment plate on a second side of the attachment plate, opposite from the first side of the attachment plate where the grip attachment is located. The tensioning element may include a spring and/or a screw (or the like). The tensioning element may provide stability to the grip attachment.

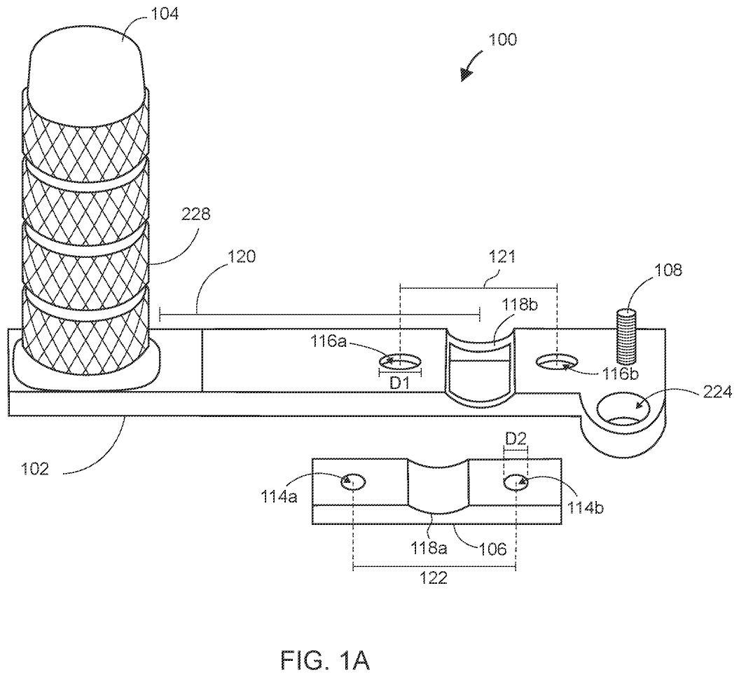

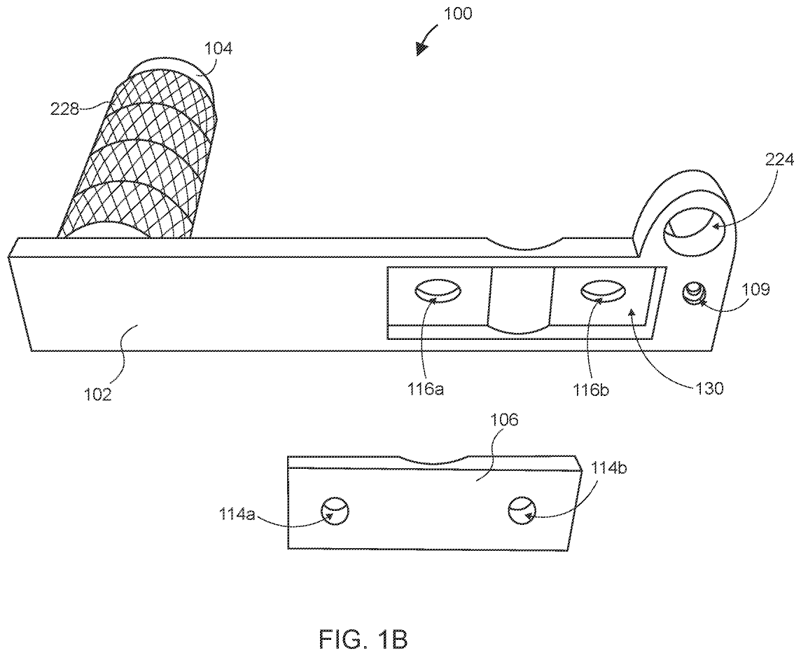

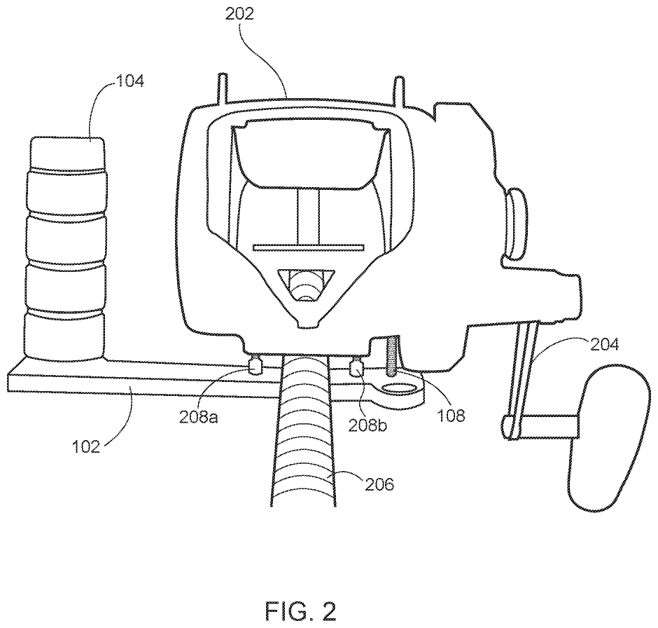

FIGS. 1A-1B illustrate different views of an example embodiment of grip attachment 100 for a rail rod and reel assembly. FIG. 2 shows a reel and rod assembly including the grip attachment 100 of FIGS. 1A-1B. In some embodiments, grip attachment 100 may include an attachment plate 102, a grip handle 104, a removable mounting plate 106, and a tensioning element 108. FIG. 1A shows a perspective view of grip attachment 100 including a first surface (e.g., top surface) of attachment plate 102 and FIG. 1B shows a perspective view of grip attachment 100 including a second surface (bottom surface of attachment plate 102). FIG. 1A-1B shows the grip attachment 100 with the attachment plate 102 and the removable mounting plate 106 separated. While in use, the removable mounting plate 106 may reside in cutout 130, discussed in further detail below. The grip attachment 100 may be a removable attachment for a fishing reel and rod. During the process of reeling in large fish, such as tuna, the rod is leveraged like a seesaw on a rail of a boat. In some embodiments, the grip attachment 100 is used to provide additional leverage while reeling in fish. For example, the grip attachment 100 may provide additional mechanical leverage, increasing the control of the rod and reel. For example, the grip attachment 100 may provide a place (e.g., grip handle 104) for the non-reeling hand to grasp to provide additional mechanical leverage. Additionally, and in some embodiments, the grip attachment 100 may provide additional stability to the rod and reel assembly for the user while reeling in fish. Additionally, and in some embodiments, the grip attachment 100 may prevent the fingers of a user of the rail rod and reel assembly from being crushed against the rail of the boat.

In some embodiments, the grip attachment 100 may include a subset of above components. For example, in some embodiments, the grip attachment 100 includes an attachment plate 102 and grip handle 104 without a removable mounting plate 106 (e.g., the structure representing the removeable mounting plate in FIGS. 1A-1B are optionally replaced by attachment plate 102) and without a tensioning element 108. In some embodiments, the grip attachment 100 includes an attachment plate 102, grip handle 104, and a removable mounting plate 106 without a tensioning element 108. In some embodiments, the grip attachment 100 includes an attachment plate 102, grip handle 104, and a tensioning element 108 without a removable mounting plate 106.

In some embodiments, the attachment plate 102 includes a plurality of bolt holes including at least a first bolt hole 116a and second bolt hole 116b having a first pitch 121. The first pitch 121 can correspond to a pitch of the rod mounting plate/screws for a particular reel or class of reels. In some embodiments, the grip attachment 100 is a universal attachment for any rod and reel (or at least more universal attachment for a larger number of rods/reels), as the attachment plate 102 is configured to receive a removable mounting plate 106. In some embodiments, the second surface of the attachment plate 102, as shown in FIG. 1B and the removeable mounting plate 106 are flush. In some embodiments, the removable mounting plate 106 is secured to the attachment plate 102 by the bolts, as shown in FIG. 2. In some embodiments, the removable mounting plate 106 may be additionally or alternatively be attached to attachment plate 102 with a separate set of mechanical attachments (e.g., screws, bolts, and/or O-rings), Velcro, adhesive, and/or the like. In some embodiments, a plurality of removable mounting plates 106 can be available and interchangeable with attachment plate 102. For example, a user of grip attachment 100 may possess a plurality of removable mounting plates 106, each of which corresponds to different bolt hole sizes, different bolt hole pitches and/or different bolt hole locations corresponding to different reels. The user can insert the appropriate removeable mounting plate corresponding to the desired reel. In some embodiments, removable mounting plates 106 may include different rod groove segment 118a sizes to accommodate different sizes of rods.

In some embodiments, the attachment plate 102 may receive the removable mounting plate 106 on a surface opposite the surface of which the grip handle 104 is located. FIG. 1B shows a cutout 130, which creates a recessed area for removable mounting plate 106 to reside. In some embodiments, attachment plate 102 may not include cutout 130. The removable mounting plate 106 may include a plurality of bolt holes 114a-b that, when inserted into attachment plate 102, at least partially align with the plurality of bolt holes 116a-b on attachment plate 102, such that the bolt holes 114a-b and 116a-b are at least partially overlapping. In some embodiments, plurality of bolt holes 114a-b may be smaller than the plurality of bolt holes 116a-b. For example, the dimension (d1) of bolt holes 114a-b may be smaller than the dimension (d2) of bolt holes 116a-b. In some embodiments, the dimension of the bolt hole may be the diameter of the bolt hole. In some embodiments, bolt holes 114a-b and bolt holes 116a-b may be circular or elliptical (or another shape). For example, the bolt holes 114a-b may be circular while bolt holes 116a-b are elliptical. Following this example, bolt holes 116a-b may have a dimension (d1), which may represent a major axis parallel to the line representing the first pitch 121 in FIG. 1A. This may provide flexibility of the pitch of the bolt holes for the removable mounting plate 106 along the major axis. The major axis may be greater than a diameter of the aforementioned circular bolt holes. Additionally, and in some embodiments, bolt holes 114a-b may have a different pitch than bolt holes 116a-b. For example, bolt holes 114a-b may have a second pitch 122 different than the first pitch 121 of bolt holes 116a-b. In some embodiments, removable mounting plate 106 and attachment plate 102 may each have more than two bolt holes. For example, removable mounting plate 106 and attachment plate 102 may each have 4, 6, or 8 bolt holes. In some embodiments, the number of bolt holes in removable mounting plate 106 may correspond to the number of bolt holes in attachment plate 102 (e.g., the same number, or at least more bolt holes in attachment plate 102 than in removeable mounting plate 106). Alternatively, and in some embodiments, the number of bolt holes in removable mounting plate 106 may be different to the number of bolt holes in attachment plate 102. For example, the removable mounting plate 106 may have four bolt holes and the attachment plate 102 may have two bolt holes, or vice versa. In some embodiments, the location of bolt holes 114a-b of removable mounting plate 106 correspond the location at which the bolt holes of a reel, shown in FIG. 2, reside. For example, bolts 208a-b may go through bolt holes 114a-b and 116a-b to the bolt holes on the reel 202. Reels made by different manufacturers may have a different number of bolt holes or bolt holes in different locations. As such, removable mounting plate 106 may be removed and interchanged with a removable mounting plate with bolt holes in locations corresponding to the bolt hole locations of the reel that will be used. Additionally, and in some embodiments, different reels may use bolts of different sizes. In some embodiments, removable mounting plate 106 may include a bolt hole or bolt holes with a dimension (e.g., diameter) corresponding to the diameter needed for the bolt size used by the reel.

In some embodiments, the attachment plate 102 and/or the removable mounting plate 106 may include a rod groove formed from rod groove segments 118a-b of the removable mounting plate 106 and attachment plate 102, respectively (or formed without segments in embodiments with an attachment plate 102 without removeable mounting plate). The rod groove represented by rod groove segments 118a-b is configured to receive the rod. The rod groove may be concave in order to receive a circular or oval-shaped rod 206. The rod 206 is held in place, as shown in FIG. 2, between the attachment plate 102 and the reel 202. In some embodiments, the rod groove is disposed between the bolt holes with rod groove segment 118a disposed between bolt holes 114a-b and rod groove segment 118b disposed between bolt holes 116a-b. In some embodiments, the rod groove is located in the center of the bolt holes (e.g., at half pitch). In some embodiments, rod groove formed from rod groove segments 118a-b may take on the curvature of the rod, such that the rod fits and is held between the reel and the grip attachment 100 when the mounting bolts are in place. In some embodiments, rod groove segments 118a and 118b are used together to secure the rod. As shown in FIG. 2, the rod 206 is secured in between the two bolts 208a-b on the rod groove 118a-b. In some embodiments, different removable attachment plates may result in different rod grooves. For example, rod groove segment 118a of different removable attachment plates may have different curvatures corresponding to different rods. In some embodiments, rod groove segment 118b may have a first curvature whereas rod groove segment 118a may have a second, different curvature. In some embodiments, rod groove segment 118b projects through the opening in rod groove segment 118a to better secure a narrower rod.

In some embodiments, the grip handle 104 is located on the attachment plate 102 on a surface opposite the removable mounting plate 106. In some embodiments, the grip handle 104 is located on a surface of the attachment plate 102 facing the reel crank 204, as shown in FIG. 2. Additionally, the grip handle 104 may be on an opposite side along the surface of attachment plate 102 from the reel crank 204, as shown in FIG. 2. Specifically, grip handle 104 may be opposite from the attachment of the reel crank 204 to the body of the reel 202. In some embodiments, grip handle 104 is not detachable from the attachment plate 102 (e.g., the attachment plate 102 and grip handle 104 are formed from a single piece of material). Alternatively, grip handle 104 is attachable to and/or detachable from the attachment plate 102. The grip handle 104 is configured to be held by a first hand of a user to provide control while a second hand of the user operates the reel crank 204, shown in FIG. 2. As such, the grip handle 104 is on a side of the attachment plate opposite from a reel crank. As shown in FIGS. 1-2, the grip handle 104 is on the left side. However, in some instances (e.g., the user uses a left-handed reel crank), the grip handle 104 may be on the right side of the attachment plate 102. In such instances, other features on attachment plate 102 may be mirrored, as well. For example, the tensioning element 108 may be on the left side of the attachment plate 102, opposite from the grip handle 104. In some embodiments, it may be advantageous to position the grip handle 104 opposite the reel crank 204 to prevent the user's hands from being caught against the rail of the fishing boat where the rod is resting. Additionally, the positioning may prevent the user's hands from getting caught in the reel or interfering with the reeling movements.

In some embodiments, the grip handle 104 is protruding from the attachment plate 102. In some embodiments, the grip handle 104 is protruding from the surface away from the surface at which the removable mounting plate 106 is located. In some embodiments, the grip handle 104 is protruding parallel to the reel 202, as shown in FIG. 2. In some embodiments, the grip handle 104 is perpendicular to the attachment plate 102. Alternatively, and in some embodiments, the grip handle 104 may not be perpendicular to the attachment plate 102. For example, the grip handle may be within a threshold angle of perpendicular to the attachment plate 102. For the example, the threshold angle is optionally ±1°, ±5°, ±10°, ±15°, ±30°, etc.

In some embodiments, grip handle 104 includes knurling 228. Knurling 228 on grip handle 104 may increase the friction on the grip handle 104, therefore improving the grip a user has on the grip handle 104. The knurling 228 may have a cross-hatching pattern. In some embodiments, the knurling is implemented with multiple bands of knurling on the grip handle 104. For example, there may be 1-8 bands of knurling spanning the length of the grip handle 104. In some embodiments, grip handle 104 may include and/or be coated in rubber, silicon, and/or plastics, which may further improve the grip a user has on the grip handle 104.

In order for grip attachment 100 to provide additional leverage for reeling in fish, the grip handle 104 may be a threshold distance 120 away from the rod, which is shown in FIG. 2. Specifically, the threshold distance 120 may be a distance from the center of the grip handle 104 to the center of the rod groove segment 118b. For example, the threshold distance is optionally between 4 inch-8 inches. The grip handle 104 may be a threshold distance from the rod such that a user may grasp the grip handle 104 without their hands touching the reel 202.

In some embodiments, grip attachment 100 includes a tensioning element 108. Tensioning element 108 may be located on the attachment plate 102 and project from the same surface of the attachment plate 102 as the grip handle 104. In some embodiments, tensioning element 108 is attachable to/detachable from the attachment plate 102. Alternatively, tensioning element 108 may not be detachable from the attachment plate 102. In some embodiments, tensioning element 108 may reside in a hole having a wider diameter at the first surface (e.g. the surface containing the grip handle 104) than at the second surface (e.g., the surface containing the cutout 130) of the attachment plate 102. Alternatively, and in some embodiments, tensioning element 108 may reside in a hole having a wider diameter at the second surface than at the first surface, as shown by hole 109 in FIG. 1B. In some embodiments, tensioning element 108 (e.g., having a diameter of the smaller diameter of hole 109) may be inserted into hole 109 such that the tensioning element 108 is protruding from the first surface. A washer, or other mechanical faster, having the wider diameter of hole 109, may be placed on the tensioning element at the second surface to secure the tensioning element onto attachment plate 102. In some embodiments, tensioning element 108 may be used as a counter force against the force of the bolts securing the attachment plate 102 to the reel and rod assembly. For example, the tensioning element 108 may include a spring and/or a screw. In some embodiments, tensioning element 108 may rest against the base of the reel, as shown in FIG. 2. For example, the force of the tensioning element 108 against the base of the reel may counteract the force of the bolts between the attachment plate 102 and the reel. As such, the tensioning element 108 may prevent erroneous movement of the grip attachment 100 relative to the reel. In some embodiments, tensioning element 108 may include and/or be coated in rubber, silicon, and/or plastics to prevent the tensioning element 108 from damaging the reel 202 or from potentially hurting a user of the grip attachment 100.

In some embodiments, the components of grip attachment 100 may be composed of various materials. For example, all the components may be composed of metals such as aluminum or steel. In some embodiments, the components may be composed of a metal alloy, such as an aluminum alloy or a steel alloy. In some embodiments, the components may be composed of carbon fiber, fiber glass, or the like. In some embodiments, the tensioning element 108 may be composed of aluminum whereas the attachment plate 102, the removable mounting plate 106, and the grip handle 104 may be composed of steel. In some embodiments, the components of grip attachment 100 may be composed of plastics. In some embodiments, the components of grip attachment 100 may be composed of a combination of materials, such as those as discussed above.

In some embodiments, grip attachment 100 may include a lanyard hole 224. In some embodiments, the lanyard hole 224 may be on the same surface of attachment plate 102 as the grip handle 104. In some embodiments, the lanyard hole 224 may be on the same side of the attachment plate at the tensioning element 108. In some embodiments, the lanyard hole 224 may be used while storing the grip attachment 100. For example, the lanyard hole 224 may be used to hang the grip attachment 100 on a hook, or the like. For example, a lanyard clip may clip onto the lanyard hole 224. In some embodiments, the removable mounting plate 106 may include a lanyard hole (not shown), which may be used for the aforementioned purposes. Additionally, the lanyard hole on the removable mounting plate 106 and/or the attachment plate 102 may be used to prevent the components from falling during mounting/unmounting, when not otherwise secured to the rod and reel assembly.

Some embodiments are directed to a grip attachment for a rail rod and reel assembly, comprising: an attachment plate wherein the attachment plate has a plurality of bolt holes with a first dimension and a first pitch, and a grip handle protruding from a first surface of the attachment plate on a first side of the attachment plate opposite from a reel crank. Alternatively or additionally, in some embodiments, the attachment plate includes a removable mounting plate. Alternatively or additionally, in some embodiments, the removable mounting plate is received by the attachment plate at the second surface of the attachment plate, opposite the first surface of the attachment plate, and has a second plurality of bolt holes with a second dimension smaller than the first dimension and a second pitch different than the first pitch, the first plurality of bolt holes and the second plurality of bolt holes at least partially overlapping. Alternatively or additionally, in some embodiments, the removable mounting plate includes bolt holes that align with bolt holes of the reel. Alternatively or additionally, in some embodiments, the attachment plate includes a rod groove corresponding to a shape of a rail rod. Alternatively or additionally, in some embodiments, the grip handle is configured to be held by a first hand of a user to provide control while a second hand of the user operates the reel crank. Alternatively or additionally, in some embodiments, the first dimension is a first dimeter. Alternatively or additionally, in some embodiments, the grip handle is perpendicular to the attachment plate. Alternatively or additionally, in some embodiments, the grip attachment further comprises a tensioning element protruding from the first surface of the attachment plate on a second side of the attachment plate, opposite the first side of the attachment plate. Alternatively or additionally, in some embodiments, the tensioning element includes a spring. Alternatively or additionally, in some embodiments, the tensioning element includes a screw.

Some embodiments are directed to a grip attachment for a rail rod and reel assembly, comprising: an attachment plate configured to receive a removable mounting plate, wherein the attachment plate has a plurality of bolt holes with a first dimension (e.g., first diameter) and a first pitch, and a rod groove that takes the shape of a rail rod, a removable mounting plate received by the attachment plate at the second surface of the attachment plate, opposite the first surface of the attachment plate, and having a second plurality of bolt holes with a second dimension (e.g., second diameter) smaller than the first dimension (e.g., first diameter) and a second pitch different than the first pitch, the first plurality of bolt holes and the second plurality of bolt holes at least partially overlapping, and a grip handle protruding from a first surface of the attachment plate on a first side of the attachment plate. Alternatively or additionally, in some embodiments, the removable mounting plate includes bolt holes that align with bolt holes of a reel. Alternatively or additionally, in some embodiments, the grip handle is perpendicular to the attachment plate. Alternatively or additionally, in some embodiments, the grip handle on the first side of the attachment plate is opposite from the side of a reel crank corresponding the second side of the attachment plate. Alternatively or additionally, in some embodiments, the grip handle further comprises a tensioning element (e.g., tension screw) protruding from the first surface of the attachment plate on a second side of the attachment plate, opposite the first side of the attachment plate.

Some embodiments are directed to a grip attachment for a rail rod and reel assembly, comprising: an attachment plate configured to receive a removable mounting plate, wherein the attachment plate has a plurality of bolt holes with a first diameter and a first pitch, and a rod groove configured to hold the rail rod, a grip handle protruding from a first surface of the attachment plate on a first side of the attachment plate, and a tensioning element configured to protrude from the first surface of the attachment plate on a second side of the attachment plate, opposite the first side of the attachment plate. Alternatively or additionally, in some embodiments, the grip handle is perpendicular to the attachment plate. Alternatively or additionally, in some embodiments, the tensioning element includes a spring. Alternatively or additionally, in some embodiments, the tensioning element includes a screw. Alternatively or additionally, in some embodiments, a removable mounting plate is received by the attachment plate at the second surface of the attachment plate, opposite the first surface of the attachment plate, and having a second plurality of bolt holes with a second diameter smaller than the first diameter and a second pitch different than the first pitch, the first plurality of bolt holes and the second plurality of bolt holes at least partially overlapping.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

1. A grip attachment for a rail rod and reel assembly, comprising:
an attachment plate wherein the attachment plate has a first plurality of bolt holes with a first dimension and a first pitch; and
a grip handle protruding from a first surface of the attachment plate on a first side of the attachment plate opposite from a reel crank.

2. The grip attachment of claim 1, wherein the attachment plate includes a removable mounting plate.

3. The grip attachment of claim 2, wherein the removable mounting plate is received by the attachment plate at a second surface of the attachment plate, opposite the first surface of the attachment plate, and has a second plurality of bolt holes with a second dimension smaller than the first dimension and a second pitch different than the first pitch, the first plurality of bolt holes and the second plurality of bolt holes at least partially overlapping.

4. The grip attachment of claim 2, wherein the removable mounting plate includes bolt holes that align with bolt holes of a reel.

5. The grip attachment of claim 1, wherein the attachment plate includes a rod groove corresponding to a shape of a rail rod.

6. The grip attachment of claim 1, wherein the first dimension is a first diameter.

7. The grip attachment of claim 1, wherein the grip handle is perpendicular to the attachment plate.

8. The grip attachment of claim 1, further comprising a tensioning element protruding from the first surface of the attachment plate on a second side of the attachment plate, opposite the first side of the attachment plate.

9. The grip attachment of claim 8, wherein the tensioning element includes a spring.

10. The grip attachment of claim 8, wherein the tensioning element includes a screw.

11. A grip attachment for a rail rod and reel assembly, comprising:
an attachment plate configured to receive a removable mounting plate, wherein the attachment plate has a first plurality of bolt holes with a first dimension and a first pitch, and a rod groove;
a removable mounting plate received by the attachment plate at a second surface of the attachment plate, opposite a first surface of the attachment plate, and having a second plurality of bolt holes with a second dimension smaller than the first dimension and a second pitch different than the first pitch, the first plurality of bolt holes and the second plurality of bolt holes at least partially overlapping; and
a grip handle protruding from the first surface of the attachment plate on a first side of the attachment plate.

12. The grip attachment of claim 11, wherein the removable mounting plate includes bolt holes that align with bolt holes of a reel.

13. The grip attachment of claim 11, wherein the grip handle is perpendicular to the attachment plate.

14. The grip attachment of claim 11, wherein the grip handle on the first side of the attachment plate is opposite from a reel crank corresponding to a second side of the attachment plate.

15. The grip attachment of claim 11, further comprising a tension screw protruding from the first surface of the attachment plate on a second side of the attachment plate, opposite the first side of the attachment plate.

16. A grip attachment for a rail rod and reel assembly, comprising:
an attachment plate configured to receive a removable mounting plate, wherein the attachment plate has a first plurality of bolt holes with a first diameter and a first pitch, and a rod groove configured to hold the rail rod;
a grip handle protruding from a first surface of the attachment plate on a first side of the attachment plate; and
a tensioning element configured to protrude from the first surface of the attachment plate on a second side of the attachment plate, opposite the first side of the attachment plate.

17. The grip attachment of claim 16, wherein the grip handle is perpendicular to the attachment plate.

18. The grip attachment of claim 16, wherein the tensioning element includes a spring.

19. The grip attachment of claim 16, wherein the tensioning element includes a screw.

20. The grip attachment of claim 16, wherein a removable mounting plate is received by the attachment plate at a second surface of the attachment plate, opposite the first surface of the attachment plate, and having a second plurality of bolt holes with a second diameter smaller than the first diameter and a second pitch different than the first pitch, the first plurality of bolt holes and the second plurality of bolt holes at least partially overlapping.
